(19) United States
(12) Patent Application Publication
(10) Pub. No.: US 2014/0089843 A1
(43) Pub. Date: Mar. 27, 2014

(54) INFORMATION PROCESSING APPARATUS AND METHOD OF CONTROLLING THE SAME, AND STORAGE MEDIUM THEREOF

(71) Applicant: CANON KABUSHIKI KAISHA, Tokyo (JP)

(72) Inventor: Yosuke Yoshida, Yokohama-shi (JP)

(73) Assignee: CANON KABUSHIKI KAISHA, Tokyo (JP)

(21) Appl. No.: 14/013,742

(22) Filed: Aug. 29, 2013

(30) Foreign Application Priority Data
Sep. 25, 2012 (JP) 2012-211532

(51) Int. Cl. G06F 3/0485

(52) U.S. Cl. CPC G06F 3/0485
USPC 715/784

(57) ABSTRACT

An information processing apparatus having a display unit, method of controlling the same, and a storage medium. The apparatus detects a user operation on a display screen of the display unit, determines that a scroll on a scroll area of the display unit is instructed in a case where it is detected that the user operation continues inside the scroll area after a starting point of the user operation outside of the scroll area of the display screen is detected, and scrolls an image displayed on the scroll area in a case that it is determined that the scroll is instructed.

### BACKGROUND OF THE INVENTION

1. Field of the Invention

The present invention relates to an information processing apparatus that is capable of scrolling in accordance with a user operation on a display screen, and to a method of controlling the same, and a storage medium thereof.

2. Description of the Related Art

In recent years, computer devices having touch panels are widely used. On such computer devices, when some kind of content is displayed in a list on the screen, and a flick operation is performed on the list, the list is caused to scroll. With this, intuitive and easy to understand operability for the user is achieved.

However, with the above described flick operation, because it is necessary to complete the operation within content for which the flick operation is valid, there are cases in which although the user intends to perform a flick operation, instead a tap operation or the like is erroneously determined. For example, in a case where the flick operation is performed from the edge of content for which the flick operation is valid towards the outside of the content, because a sufficiently large movement amount of a finger is not detected within the region of the content, a tap operation ends up being determined.

As a solution to this kind of problem, there is a technique in which even in a case where a flick operation is performed from the edge of the touch panel (an area in which the flick operation is valid) towards the outside of the touch panel, it is recognized correctly as a flick operation (see Japanese Patent Laid-Open No. 2011-118629).

By the above described conventional technique, a flick operation from the edge of an area for which the flick operation is valid towards the outside of the area is correctly recognized. However, with the above described conventional technique, a flick operation from outside of an area for which the flick operation is valid towards the inside of the area is not correctly recognized. Because of this, particularly for content for which the scroll range is large, not only can the feature of scroll by flick operation not be made use of but also there exists the problem that operability is worsened.

For example, it can be thought that a user, when scrolling by flick operation a list, such as an address book, for which the scroll range is large, will vigorously perform consecutive flick operations in order to quickly cause the information that he or she desires to be displayed. In such a case there is the possibility that the user will erroneously perform a flick operation from outside of a display area of the list for which the flick operation is valid. In this case, because the performance of the flick operation on the list will not be recognized and the scrolling of the list will not be performed, the operability that the user expects will not be realized.

### SUMMARY OF THE INVENTION

An aspect of the present invention is to eliminate the above-mentioned problems with the conventional technique.

A feature of the present invention is to provide a technique in which a scroll operation from an outside of a scroll area towards the inside of the scroll area is detected, and a scroll instruction for display in the scroll area is made possible.

According to an aspect of the present invention, there is provided an information processing apparatus having a display unit, comprising a detection unit configured to detect a user operation on a display screen of the display unit, a determination unit configured to determine that a scroll on a scroll area of the display screen is instructed in a case where the detection unit detected that the user operation continues inside the scroll area after the detection unit detected a starting point of the user operation outside of the scroll area and a scroll unit configured to scroll an image displayed on the scroll area, in accordance with a direction of the user operation, in a case that the determination unit determines that the scroll is instructed.

According to another aspect of the present invention, there is provided a method of controlling an information processing apparatus having a display unit, the control method comprising detecting a user operation on a display screen of the display unit, determining that a scroll on a scroll area of the display unit is instructed in a case where it is detected in the detecting step that the user operation continues inside the scroll area after a starting point of the user operation outside of the scroll area of the display screen is detected in the detecting step and scrolling an image displayed on the scroll area in a case that it is determined in the determining step that the scroll is instructed.

According to yet another aspect of the present invention, there is provided a non-transitory computer-readable storage medium storing a program for causing a computer to function as an information processing apparatus having a display unit, comprising a detection unit configured to detect a user operation on a display screen of the display unit, a determination unit configured to determine that a scroll on a scroll area of the display screen is instructed in a case where the detection unit detected that the user operation continues inside the scroll area after the detection unit detected a starting point of the user operation outside of the scroll area and a scroll unit configured to scroll an image displayed on the scroll area, in accordance with a direction of the user operation, in a case that the determination unit determines that the scroll is instructed.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for illustrating a hardware configuration of an information processing apparatus according to an embodiment of the present invention.

FIG. 2 is a view for illustrating an example of a display of an address book for selecting an address to be a destination of an email transmission in the information processing apparatus according to a first embodiment of the present invention.

FIG. 3 is a view for illustrating an example of a case in which a user performs a flick operation from an outside of a scroll area to an inside of the scroll area.

FIG. 4 is a view for explaining an example in which a display of a scroll area is cause to scroll by an operation method other than the flick operation (a drag operation) in the first embodiment.

FIG. 5 is a view for explaining an example in which a drag operation is initiated from outside of the scroll area and a screen is scrolled, in the first embodiment.

FIG. 6 is a flowchart for describing processing for a case in which a user performs an operation of scrolling a screen in a state in which an address book is displayed on a display unit in the information processing apparatus according to the first embodiment.

FIG. 7 is a view for illustrating an example of an operation in a case where the flick operation is performed from an operation button arranged outside of the scroll area in the information processing apparatus according to a second embodiment.

FIG. 8 is a flowchart for describing processing for a case in which a user performs an operation of scrolling a screen in a state in which the address book is displayed on the display unit in the information processing apparatus according to the second embodiment.

FIG. 9 is a view for illustrating an example in which the flick operation is performed from a point outside of a drop-down list (thick bordered area) in the information processing apparatus according to the third embodiment.

FIG. 10 is a flowchart for describing processing for a case in which a user performs an operation of scrolling a screen in a state in which the drop-down list is displayed in the information processing apparatus according to the third embodiment.

### DESCRIPTION OF THE EMBODIMENTS

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required with respect to the means to solve the problems according to the present invention.

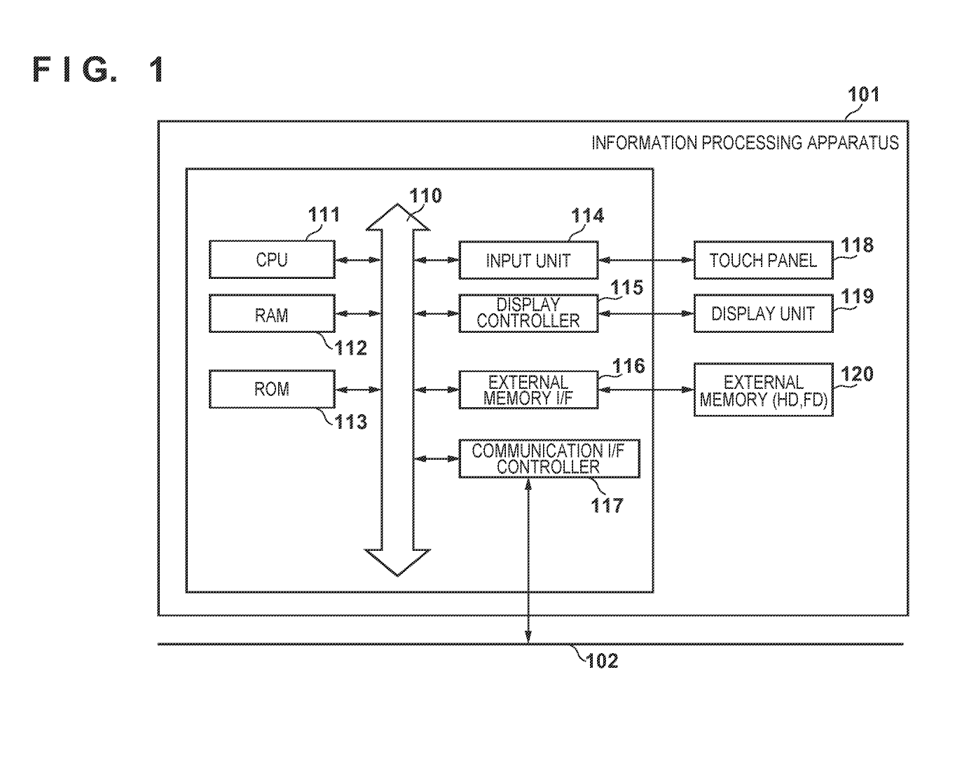

FIG. 1 is a block diagram for illustrating a hardware configuration of an information processing apparatus 101 according to an embodiment of the present invention.

In FIG. 1, a CPU 111, a RAM 112, a ROM 113, an input unit 114, a display controller 115, an external memory I/F 116 and a communication I/F controller 117 are connected to a system bus 110. Also, a touch panel 118, a display unit 119 and an external memory 120 are connected via the input unit 114, the display controller 115 and the external memory I/F 116 respectively. Each unit connected to the system bus 110 is configured to be able to perform data exchange with each other via the system bus 110.

The ROM 113 is a non-volatile memory and stores in predetermined regions image data, other data, various programs for the CPU 111 to operate and the like. The RAM 112 is a volatile memory and is used as a main memory of the CPU 111 and as a temporary storage area such as a work area. The CPU 111 controls units of the information processing apparatus 101, using the RAM 112 as a work memory, in accordance with programs stored in the ROM 113, for example. Note, the programs that the CPU 111 operates may be stored in the external memory (hard disk, etc.) 120, and are not limited to being stored in the ROM 113.

The input unit 114 receives operations from the user, generates control signals in accordance with the operations and supplies them to the CPU 111. For example, the input unit 114 may have a character information input device called a keyboard (not shown), a pointing device (not shown) or the like as input devices for accepting user operation. Note, the touch panel 118 is an input device for outputting coordinate information corresponding to a touched position to the input unit 114 that is configured as a tablet surface for example. The CPU 111 controls units of the information processing apparatus 101 in accordance with a program based on control signals generated and supplied by the input unit 114 in accordance with a user operation performed on an input device.

With this, the information processing apparatus 101 is able to execute in accordance with a user operation. The display controller 115 outputs a display signal for causing an image to display on the display unit 119. For example, a display control signal that the CPU 111 generates according to a program is supplied to the display controller 115. The display controller 115 generates a display signal based on the display control signal and outputs it to the display unit 119. For example, the display controller 115 causes a GUI screen constituted in a GUI (Graphical User Interface) to be displayed on the display unit 119 based on display control signals that the CPU 111 generates. The touch panel 118 is comprised in the same body as the display unit 119. For example, the touch panel 118 is configured so to have a light transmittance that does not obstruct display of the display unit 119 and is installed in an upper layer of a display screen of the display unit 119. Input coordinates on the touch panel 118 are associated with display coordinates on the display unit 119. With this it is possible to configure a GUI by which a user can directly operate on a screen displayed on the display unit 119.

An external memory 120 such as a hard disk (HD), an FD, a CD, a DVD, a memory card, for example, may be mountable to the external memory I/F 116. Based on control of the CPU 111, reading out of data from the mounted external memory 120 and writing out of data to the external memory 120 is performed. The communication I/F controller 117 performs communication with, for example, a network 102 such as a LAN, the Internet, a wired network, or a wireless network based on control of the CPU 111.

Note, the CPU 111 can detect the following operations on the touch panel 118 and states, for example. The touch panel 118 being touched by a finger or a pen (hereinafter referred to as a TOUCH-DOWN). A state in which the touch panel 118 is being touched by a finger or a pen (hereinafter referred to as a TOUCH-ON). A finger or a pen moving while touching the touch panel 118 (hereinafter referred to as a MOVE). A finger or a pen that was touching the touch panel 118 being released (hereinafter referred to as a TOUCH-UP). A state in which nothing is touching the touch panel 118 (hereinafter referred to as a TOUCH-OFF).

These operations, and position coordinates for where the finger or pen touch on the touch panel 118 are sent in notification to the CPU 111 through the system bus 110 and the CPU 111 determines what kind of operation was performed on the touch panel 118 based on the notified information For the MOVE, for a movement direction of the finger or pen moving on the touch panel 118, a horizontal component and a vertical component on the touch panel 118 can be determined based on a change in the position coordinates.

Also, when the TOUCH-UP is performed after performing the TOUCH-DOWN and the MOVE on the touch panel 118 it is treated as a stroke being drawn. An operation of quickly drawing a stroke is called a flick. A flick operation is an operation in which a user, with his or her finger touching the touch panel 118, quickly moves the finger a certain distance, releasing the finger in the course of this movement. In other words, it is an operation in which a user quickly traces his or her finger on the touch panel 118 in a flick. The CPU 111 detects that the MOVE was performed for greater than or equal to a predetermined distance and at greater than or equal to a predetermined speed, and from that state if the TOUCH-UP is detected, it can be determined that the flick operation was performed. Also, in a case where the MOVE was detected for greater than or equal to the predetermined distance, and from that state the TOUCH-ON is detected, a drag operation is determined to have been performed. For the touch panel 118, for example resistive type, capacitance type, surface acoustic wave type, infrared ray type, electromagnetic induction type, image recognition type, optical sensor type or any other of the various types of touch panel may be used.

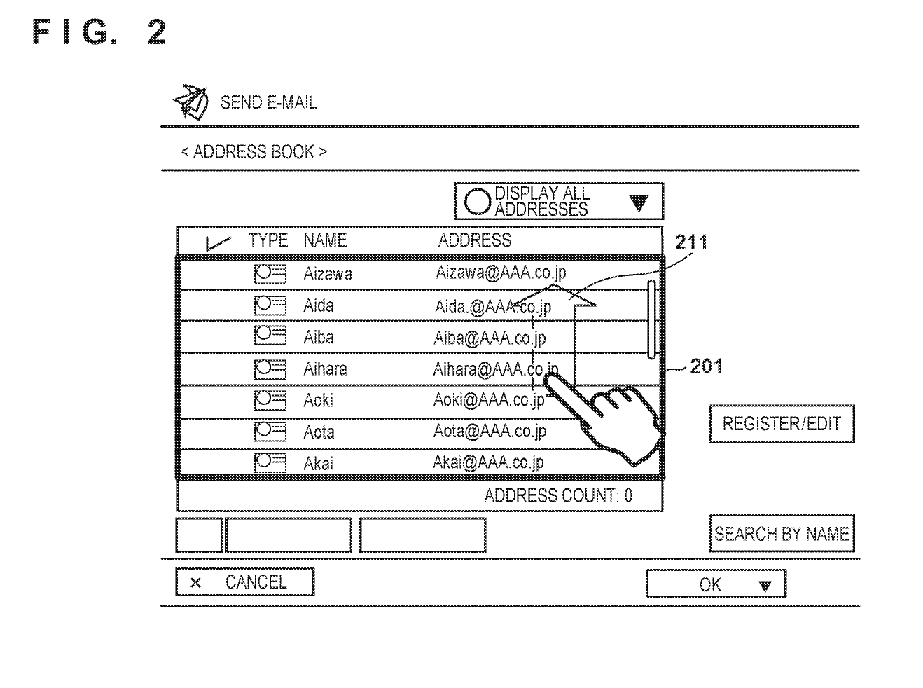

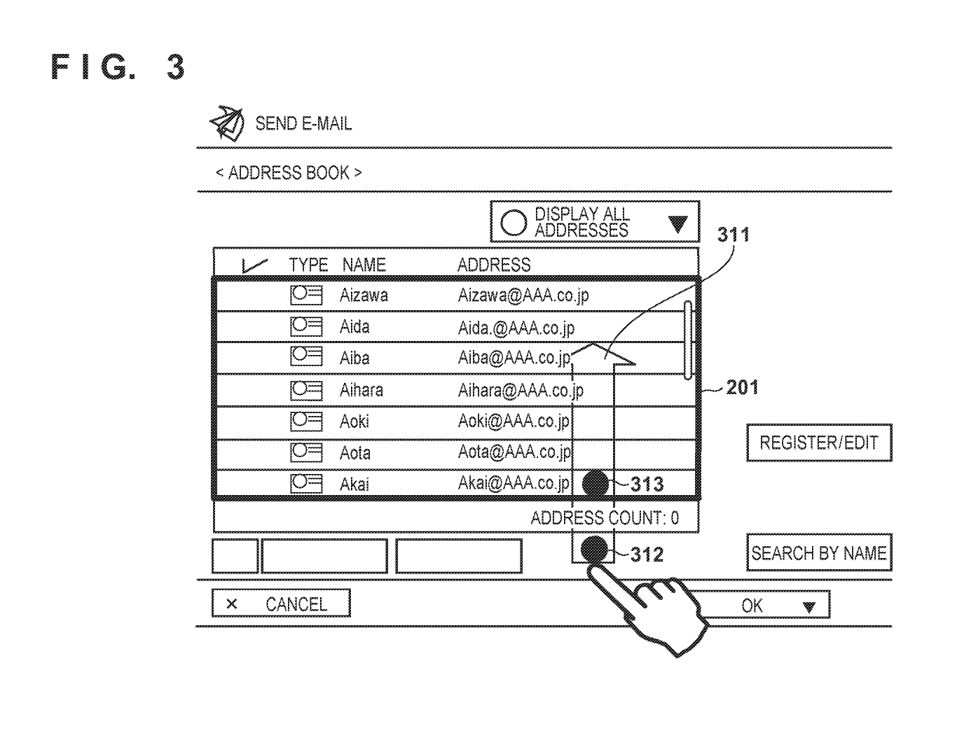

FIG. 2 and FIG. 3 are views for illustrating examples of a display of the display unit 119 of the information processing apparatus 101 according to a first embodiment of the present invention. Below, explanation will be given of example of a display on the display unit 119 in the first embodiment of the present invention with reference to FIG. 2 and FIG. 3. Note, operation such as the flick operation mentioned below are all performed on the display unit 119 of the information processing apparatus 101 and do not reach other ranges.

FIG. 2 is a view for illustrating an example of a display of an address book for selecting an address to be a destination of an email transmission in a case where the information processing apparatus 101 according to the first embodiment has an email transmission function which is a data transmission function.

Data of the address book is stored in the external memory 120 of the information processing apparatus 101. As shown in FIG. 2, in a case where the number of addresses included in the address book are many, an address list cannot be fit into a screen of the display unit 119. So, it is necessary for the user to cause the displayed address list to scroll in order to display a desired address to be displayed on the display unit 119. FIG. 2 is a view for illustrating an example in which the user performed the flick operation in the direction of an arrow 211 on a particular location on a scroll area 201 (thick bordered area) on the display unit 119 on which the address list is displayed. As shown in FIG. 2, when the user performs the flick operation in an upward direction, the address list displayed in the scroll area 201 is displayed to be scrolled in an upward direction. By the user performing the flick operation or the drag operation on the scroll area 201 the address list is displayed to be scrolled. Note, in the first embodiment, operation such as scrolling is not performed even when a flick operation or a drag operation that was initiated outside of the scroll area 201 and completes outside of the scroll area 201 is detected.

FIG. 3 is a view for illustrating an example of a case in which a user performs the flick operation from outside of the scroll area 201 to the inside of the scroll area 201.

In the first embodiment, it is decided that a flick operation was performed on the scroll area 201 if the flick operation completes within the scroll area 201 even if the flick operation was initiated from outside of the scroll area 201 (a flick operation starting point 312) in the direction of an arrow 311. In other words, in a case where after detecting the TOUCH-DOWN at the drag operation starting point 512, the MOVE and the TOUCH-UP is detected in the scroll area 201 in a state in which the TOUCH-ON is maintained, the address list displayed on the scroll area 201 is caused to scroll. In such as case, a location (a virtual flick operation starting point 313) at which the MOVE is first detected in the scroll area 201 is treated as the starting point of the flick operation, and from there up until a location at which the TOUCH-UP is detected is treated as a continuation section of the flick operation, and scroll is performed in accordance with its distance. Alternatively, the flick operation starting point 312 may be stored and treated as the starting point of the flick operation.

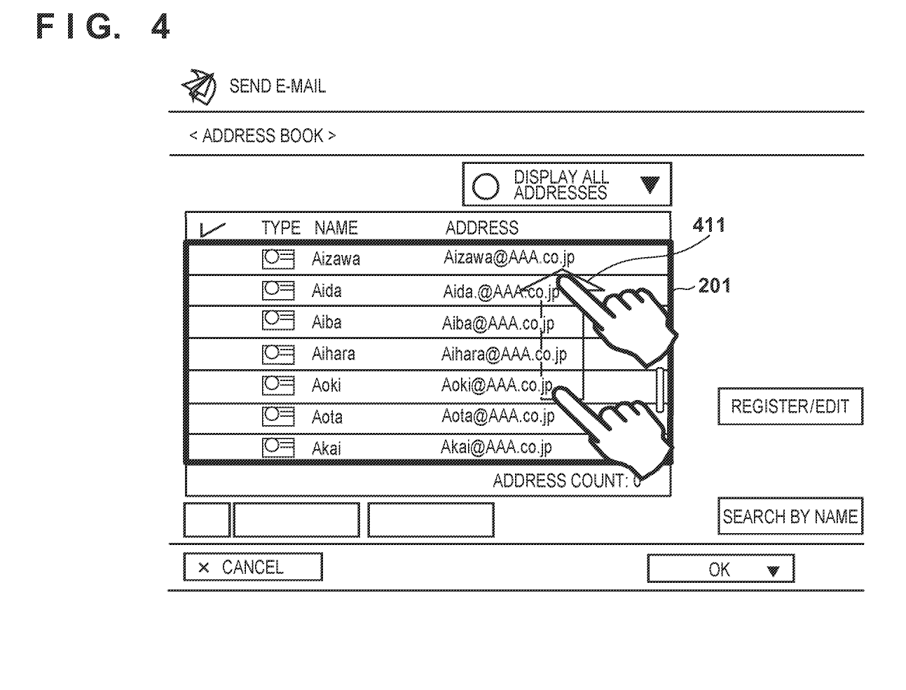

FIG. 4 is a view for explaining an example in which the scroll area 201 is caused to scroll by an operation method other than the flick operation (a drag operation) in the first embodiment. With this method, the address list is scrolled proportionally to an amount moved (distance moved) in a direction of an arrow 411 from a location at which the user performed the TOUCH-DOWN until a location at which the user performed the TOUCH-UP in the scroll area 201.

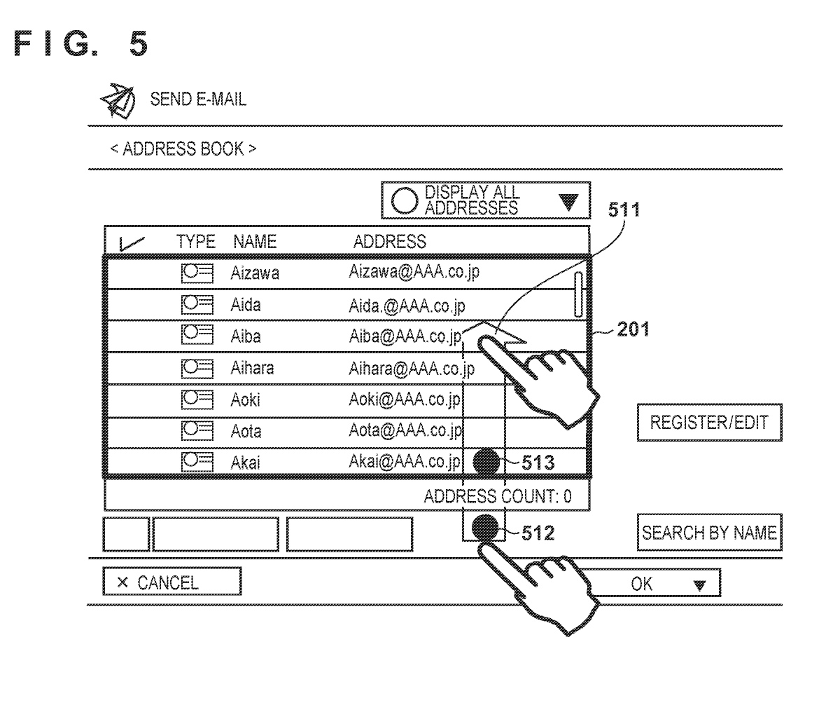

FIG. 5 is a view for explaining an example in which a drag operation is initiated from an area other than the scroll area 201 and a screen is scrolled in the first embodiment.

In the first embodiment, if the MOVE reaches the scroll area 201, it is determined that the drag operation is performed on the scroll area 201 even in a case where the TOUCH-DOWN is detected in a area other than the scroll area 201 on which the address list is displayed on the display unit 119. In other words, in a case where the MOVE is detected in the direction of an arrow 511 on the scroll area 201 in a state in which the TOUCH-ON has been maintained after the TOUCH-DOWN was detected at the drag operation starting point 512, the address list displayed on the scroll area 201 is caused to scroll in an upward direction. In this case, a location at which the MOVE is first detected in the scroll area 201 (a virtual drag operation starting point 513) is treated as a starting point of the drag operation and an amount of scroll corresponding to a movement distance of the MOVE from the virtual drag operation starting point 513 is performed.

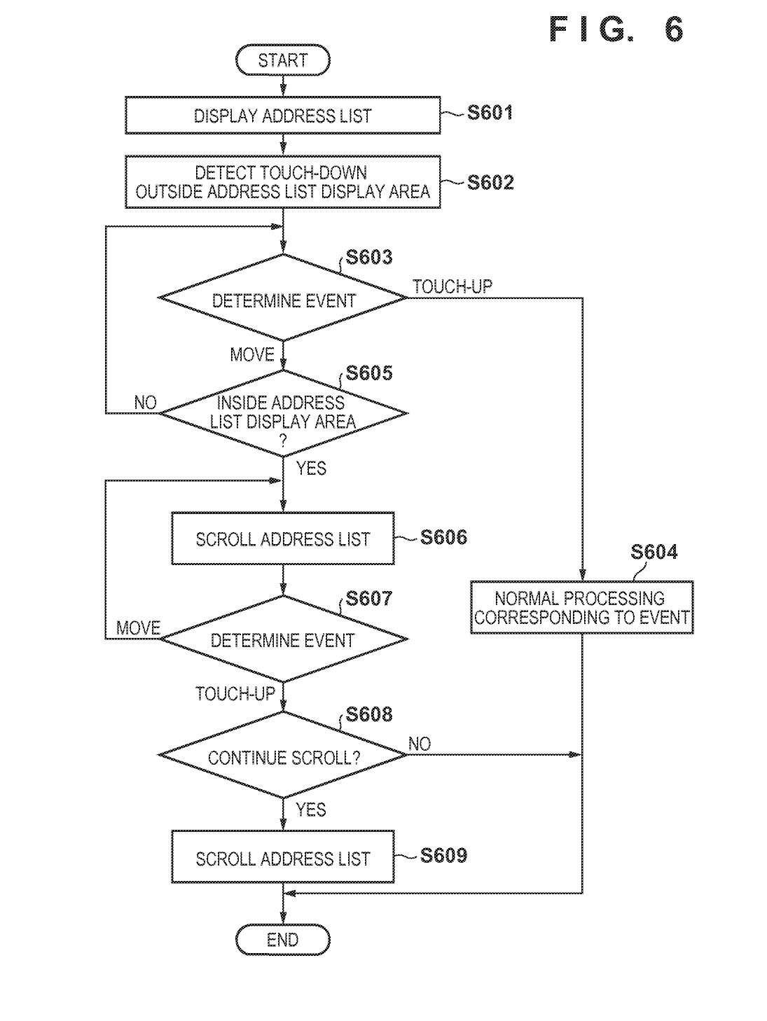

Next, with reference to FIG. 6, explanation will be given for operation of the information processing apparatus 101 according to the first embodiment.

FIG. 6 is flowchart for describing processing for a case in which a user performs an operation of scrolling a screen in a state in which the address book shown in FIG. 2 is displayed on the display unit 119 in the information processing apparatus 101 according to the first embodiment. Note, processing illustrated by the flowchart of FIG. 6 is realized by the CPU 111 executing a program loaded into the RAM 112 from the ROM 113 or from the external memory 120.

First in step S601, the CPU 111 causes the address list included in the address book to be displayed in the scroll area 201 on the display unit 119 in accordance with a predetermined operation of the user. Next, the processing proceeds to step S602 and the CPU 111 detects the TOUCH-DOWN when the TOUCH-DOWN is performed on an area other than the scroll area 201 on which the address list is displayed on the touch panel 118 on the display unit 119 by an operation of the user. If after the CPU 111 detects the TOUCH-DOWN in step S602, a user operation is once again performed, the CPU 111 determines a type of this event in step S603. In step S603, if the CPU 111 determines that the event is the TOUCH-UP, the processing proceeds to step S604 and the CPU 111 performs normal processing for that event. The content of step S604 will be explained later.

Meanwhile, in step S603, if the CPU 111 determines that the event in the MOVE, the processing proceeds to step S605 and the CPU 111 determines the region in which the event was detected. In a case where in step S605 the CPU 111 determines that the MOVE was detected outside of the scroll area 201, the processing returns to step S603. After that, in step S603, when the CPU 111 decides that the TOUCH-UP was detected, the processing proceeds to step S604 and the CPU 111 performs normal processing for the event.

In this way in the first embodiment, in a case where a tap operation (the TOUCH-ON->the TOUCH-UP) or a flick operation (the MOVE greater than or equal to a predetermined speed->the TOUCH-UP) in an area outside of the scroll area 201, in step S604 processing for that event is performed. In other words, in step S604, processing corresponding to an event on an area outside of the scroll area 201 (user operation) is performed as appropriate. For example, it is possible to conceive of processing such as performing screen transition or input of a character being the processing for a tap operation on an operation button arranged outside of the scroll area 201.

On the other hand, in a case where in step S605 the CPU 111 determines that the MOVE has occurred in the scroll area 201, the processing proceeds to step S606 and the CPU 111 causes the address list displayed in the scroll area 201 to be scrolled in a direction of the MOVE operation. After that, when once again an operation is performed by a user on the touch panel 118, the CPU 111 advances the processing to step S607 and performs determination of that event.

In a case where in step S607, the CPU 111 detects the MOVE, the processing returns to step S606 and the CPU 111 causes the address list to scroll. At this point, because it is a state in which the MOVE was detected, and from that state the TOUCH-ON was detected and scrolling was instructed, scrolling due to a drag operation is continuously performed.

On the other hand, in step S607, in a case where the CPU 111 detects the TOUCH-UP, the processing proceeds to step S608 and the CPU 111 performs determination of whether or not to continue scrolling. Specifically, it decides whether, immediately before the TOUCH-UP, the MOVE operation had been performed for greater than or equal to a predetermined distance and whether it had been performed at greater than or equal to a predetermined speed (whether scroll continuation conditions have been satisfied). In a case where in step S608 the CPU 111 decides that the scroll continuation conditions have been satisfied, the processing proceeds to step S609, the CPU 111 calculates a scroll amount from values such as a distance and a speed of the MOVE operation, and performs continuation of the scroll for that amount after the TOUCH-UP in a direction of the MOVE operation. This corresponds to scrolling due to the flick operation, for example.

On the other hand, in a case where the CPU 111 in step S608 decides that the scroll continuation conditions were not satisfied, it completes the processing without performing scrolling. This corresponds to a case in which after performing scrolling by a drag operation in the scroll area 201, the TOUCH-UP was performed after having stopped the finger, for example.

In this way, the information processing apparatus 101 according to the first embodiment can perform scrolling of the address list displayed in the scroll area 201 if the MOVE is detected in the scroll area 201 after detecting the TOUCH-DOWN in an area outside of the scroll area 201. Also, it is possible to perform scrolling of the address list displayed in the scroll area 201 by determining that a flick operation is performed if the TOUCH-UP is detected after the MOVE.

By the first embodiment, as explained above, it is possible to scroll an address list and display even in a case in which the user performed the flick operation or the drag operation from outside of the address list in the scroll area 201. For this reason, it is possible to improve operability particularly in a scene in which a flick operation is repetitively performed.

### Second Embodiment

Next, explanation will be given for a second embodiment of the present invention. In the second embodiment, explanation will be given for a case where an operation button arranged in an area outside the scroll area 201 in which the address list is displayed is pressed when the flick operation is initiated. Explanation will be given focusing on differences with the first embodiment. Note, because the hardware configuration of the information processing apparatus 101 according to the second embodiment is the same as in the previously described first embodiment, its explanation will be omitted.

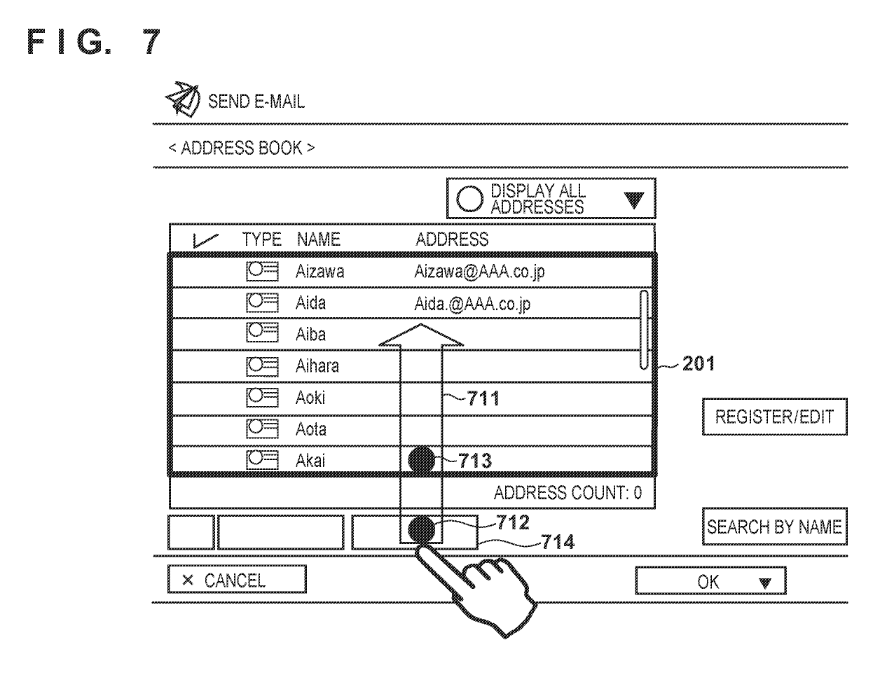

FIG. 7 is a view for illustrating an example of an operation in a case where the flick operation is performed from an operation button 714 arranged outside of the scroll area 201 in the information processing apparatus according to a second embodiment.

Here, the operation button 714 is a general GUI component and predetermined processing (screen transition, character input, etcetera. Hereinafter referred to as button processing) is performed when it a tap (the TOUCH-UP after the TOUCH-ON) is performed.

More specifically, when the TOUCH-ON is first performed on the operation button 714, the button 714 enters a pressed state. By displaying so that, for example, the color of the operation button 714 changes or that it becomes depressed, in this pressed state, it is shown that the button is being pressed. In this state, processing associated with the button 714 is not executed. When the TOUCH-UP is performed in this pressed state, the pressed state is cancelled and processing associated with the operation button 714 is executed.

As described above, when the operation button 714 of the second embodiment enters the pressed state, the pressed state is not cancelled until the TOUCH-UP is performed. In other words, even in a case where in the pressed state a finger is caused to move outside of the button 714 by the MOVE, when the pressed state is maintained and the TOUCH-UP is performed, the pressed state is cancelled and processing associated with the button 714 is performed. Note, in the second embodiment, the pressed state is cancelled and processing associated with the operation button 714 is executed regardless of the location at which the TOUCH-UP was performed. However, in a case where the TOUCH-UP is performed outside of the operation button 714, it is possible to configure such that only cancellation of the pressed state is performed and processing associated with the operation button 714 may not be executed.

In the second embodiment, the flick operation is initiated in the direction of an arrow 711 from the operation button 714 arranged outside of the scroll area 201 on which the address list is displayed on the display unit 119. If the flick operation reaches the scroll area 201, it is determined that the flick operation was performed on the scroll area 201. In this case, processing associated with the operation button 714 may not be executed.

In other words, in a case in which the MOVE and the TOUCH-UP is detected in the scroll area 201 in a state in which the TOUCH-ON is maintained after the TOUCH-DOWN was detected at a flick starting point 712, the address list displayed in the scroll area 201 is caused to scroll in an upward direction. In such as case, a location (a virtual flick operation starting point 713) at which the MOVE is first detected in the scroll area 201 is treated as the starting point of the flick operation, and from there up until a location at which the TOUCH-UP is detected is treated as a continuation section of the flick operation, and scroll is performed in accordance with its distance. Alternatively, the flick starting point 712 may stored and be treated as the starting point of the flick operation.

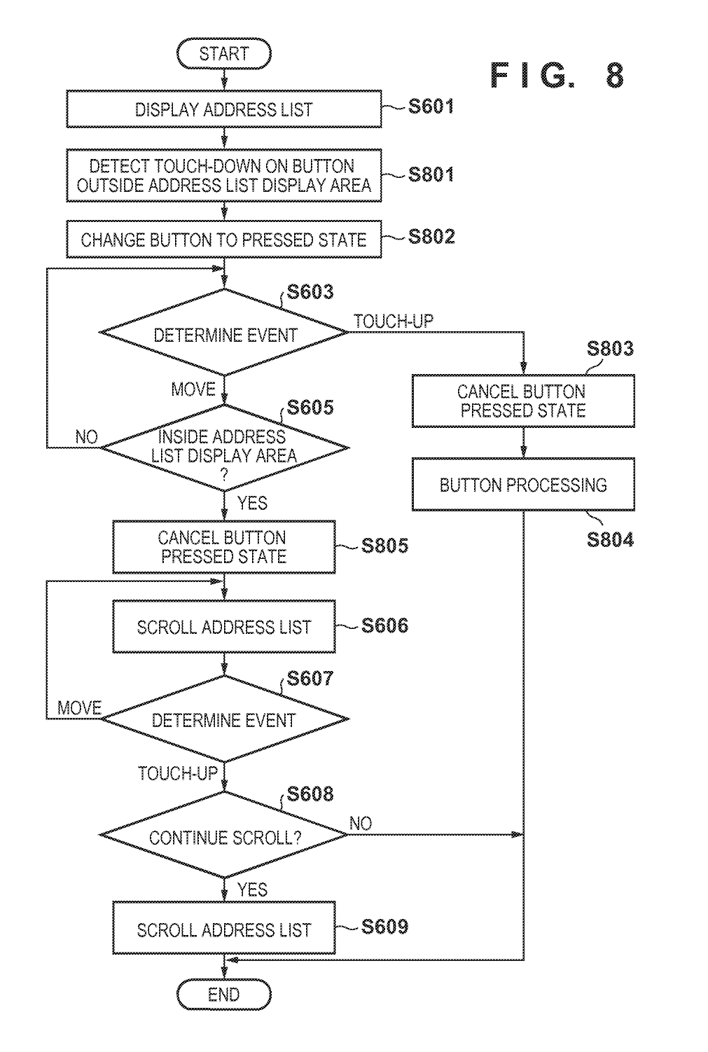

FIG. 8 is flowchart for describing processing for a case in which a user performs an operation of scrolling a screen in a state in which the address book shown in FIG. 2 is displayed on the display unit 119 in the information processing apparatus 101 according to the second embodiment. Note, processing illustrated by the flowchart of FIG. 8 is realized by the CPU 111 executing a program loaded into the RAM 112 from the ROM 113 or from the external memory 120. Note, in FIG. 8, for steps having the same processing as shown by the flowchart of previously described FIG. 6 is given the same reference numerals and explanation of these is omitted.

Due to a user operation, the TOUCH-DOWN is performed on the button 714 arranged outside of the scroll area 201 on which is displayed the list of addresses on the touch panel 118 on the display unit 119. With this, the CPU 111 in step S801 detects the TOUCH-DOWN and in step S802 the CPU 111 puts the button 714 into the pressed state and displays. When an operation by the user is performed once again on the display unit 119 after the CPU 111 detects the TOUCH-DOWN in step S801, the CPU 111 determines the type of the event in step S603.

In step S603, if the CPU 111 determines that the event is the TOUCH-UP, the processing proceeds to step S803 and the CPU 111 cancels the pressed state of the button 714 and then in step S804, the CPU 111 executes processing associated with the button 714. This is behavior for a case where a tap was performed on the button 714.

In step S603, if the CPU 111 determines that the event is the MOVE, the processing proceeds to step S605 and the CPU 111 determines the area in which the event was detected. In a case where in step S605 the CPU 111 determines that the MOVE was detected in the scroll area 201, the processing proceeds to step S805, the CPU 111 cancels the pressed state of the button 714 and the processing proceeds to step S606. By doing this, it is possible to stop the operation on the button 714 and to correctly detect the MOVE operation or the flick operation on the scroll area 201.

The information processing apparatus 101 according to the second embodiment causes the address list to scroll when the MOVE is detected in the scroll area 201 in a state in which the TOUCH-ON is maintained after the TOUCH-DOWN on the button 714 arranged outside of the scroll area 201 is detected in a direction of the MOVE operation. With this, it is possible to cause scrolling of the display even if the flick operation was from outside of the scroll area 201.

Note, in the second embodiment, explanation was given of an example of a button arranged outside of the scroll area 201 but the present invention can be adopted to other components (a check-box, a slider, etcetera) for which operation by a tap, or the like, is possible arranged outside of the scroll area 201.

### Third Embodiment

Next, explanation will be given for a third embodiment of the present invention. In the third embodiment, explanation will be given for an example of a case in which the flick operation is performed on a drop-down list. A drop-down list is a general GUI component and is a pull-down list displayed upon the tapping of a button. When an item of the list displayed in this way is selected, the selected item is displayed in the button. Note, because the hardware configuration of the information processing apparatus 101 according to the third embodiment is the same as in the previously described first embodiment, its explanation will be omitted.

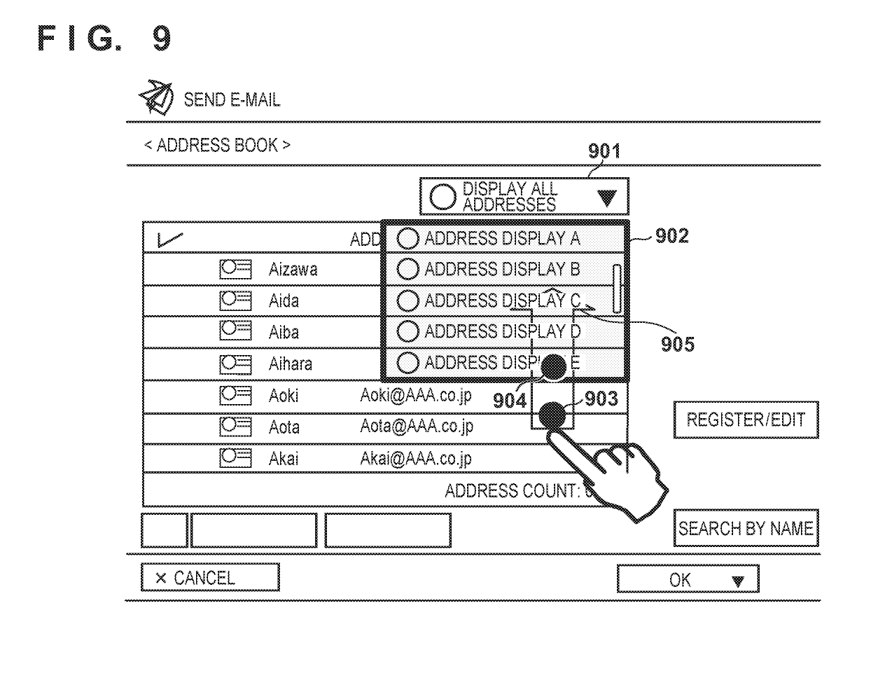

FIG. 9 is a view for illustrating an example in which the flick operation is performed from a point 903 outside of a drop-down list 902 (thick bordered area) in the direction of an arrow 905 in the information processing apparatus 101 according to the third embodiment. In the third embodiment, the drop-down list 902 is displayed when a drop-down list display button 901 is tapped. The drop-down list 902 causes a list of displayed items to scroll in accordance with a flick operation. When the drop-down list 902 is displayed, only operation on the drop-down list 902 is valid. In a case where an operation such as a tap is performed outside of the drop-down list 902, the display of the drop-down list 902 is hidden.

In the third embodiment, in a case where the flick operation is performed from outside of the drop-down list 902 displayed on the display unit 119, if the flick operation reaches the drop-down list 902, the address list displayed in the drop-down list 902 is caused to be scrolled in a direction of the flick operation. In such as a case, a location (a virtual flick operation starting point 904) at which the MOVE is first detected in the drop-down list 902 is treated as the starting point of the flick operation, and from there up until a location at which the TOUCH-UP is detected is treated as a continuation section of the flick operation, and scroll is performed in accordance with its distance.

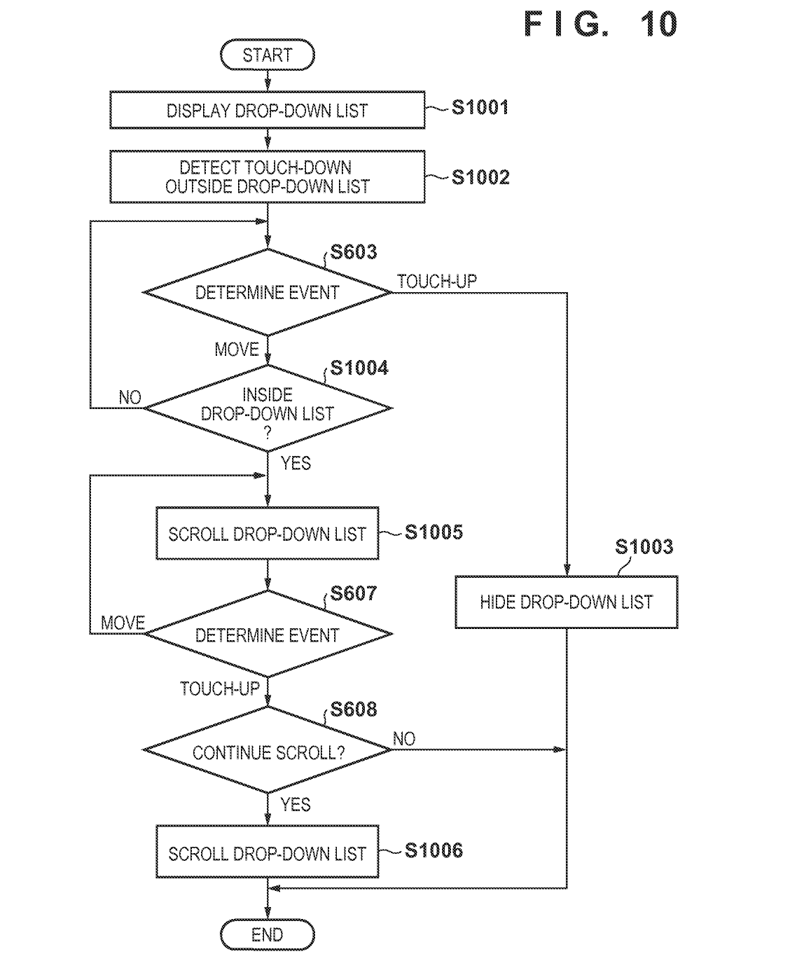

FIG. 10 is flowchart for describing processing for a case in which a user performs an operation of scrolling a screen in a state in which the drop-down list 902 is displayed in the information processing apparatus 101 according to the third embodiment. Steps that are the same as in FIG. 6 are indicated by the same reference numerals and steps that are different from FIG. 6 are indicated by different reference numerals. Below, explanation will be given for parts that differ from FIG. 6 and steps of FIG. 6 will be mentioned as well as necessary. Note, processing illustrated by the flowchart of FIG. 10 is realized by the CPU 111 executing a program loaded into the RAM 112 from the ROM 113 or from the external memory 120.

First, in step S1001 when the user performs a tap on the drop-down list display button 901 displayed in the display unit 119, the CPU 111 and the display controller 115 cause the drop-down list 902 to be displayed on the display unit 119. When the TOUCH-DOWN is performed on the touch panel 118 on the display unit 119 due to a user operation, the CPU 111 in step S1002 detects the TOUCH-DOWN. When, operation is once again performed by the user on the touch panel 118 after the CPU 111 detects the TOUCH-DOWN outside of the drop-down list 902 in step S1002, the CPU 111, in step S603, determines the type of the event.

In step S603, if the CPU 111 determines that the event is the TOUCH-UP operation, the processing proceeds to step S1003 and the CPU 111 hides display of the drop-down list 902 and completes the processing. Also, in step S603, if the CPU 111 determines that the event is the MOVE operation, the processing proceeds to step S1004 and the CPU 111 determines the area in which the event occurred. In step S1004, if the CPU 111 determines that the event occurred outside of the drop-down list 902, the processing returns to step S603. On the other hand, in a case where the CPU 111, in step S1004, determines that the event occurred within the drop-down list 902, the processing proceeds to step S1005, and the CPU 111 causes the drop-down list 902 to scroll. After that, if an operation is once again performed by the user on the touch panel 118, the CPU 111 moves the processing to step S607 and performs determination processing for the event. In a case where, in step S607, the CPU 111 detects the MOVE, the processing returns to step S1005 and the CPU 111 causes the drop-down list 902 to scroll in a direction of the MOVE operation. At this point, the state is such that the MOVE was detected and from that state the TOUCH-ON was detected, the state is one in which the scrolling of the drop-down list 902 is being performed by the drag operation.

On the other hand, in a case where the CPU 111, in step S607, detects the TOUCH-UP, the processing proceeds to step S608 and the CPU 111 determines whether or not the scroll continuation conditions are satisfied. If it is determined, in step S608, that the scroll continuation conditions are satisfied, the processing proceeds to step S1006, the CPU 111 calculates a scroll amount from values such as the distance and the speed of the move operation, and continuously executes scrolling of the drop-down list 902 by that amount after the TOUCH-UP.

If the MOVE is detected in the drop-down list 902 when the TOUCH-ON is maintained after the TOUCH-DOWN is detected outside of the drop-down list 902 by the information processing apparatus 101 according to the third embodiment, the drop-down list 902 is caused to be scrolled. With this, even in a case where the user performed a flick operation from the outside of the drop-down list 902, it is possible to cause the list of addresses displayed in the drop-down list 902 to scroll, and so operability of the flick operation is improved.

Note, in the above described first to third embodiments, a case of a flick operation was explained, but the present invention may also be adopted for the case of a drag operation in the same way. For example, in the third embodiment, if the MOVE is detected in the drop-down list 902 in a state in which the TOUCH-ON is maintained after the TOUCH-DOWN is detected outside of the drop-down list 902, the list of addresses displayed in the drop-down list 902 may be caused to scroll.

Also, in the third embodiment, explanation was given for a drop-down list, but it is possible to adopt for lists having similar functions, to menus, and the like (combo-boxes, pop-up lists, choices, etcetera).

### Other Embodiments

Explanation has been given based on preferred embodiments of the present invention, but the present invention is not limited to particular embodiments and the present invention includes various embodiments within its scope and spirit. Detailed description has been given based on the best mode of the present invention, but the present invention is not limited to these embodiments and various embodiments within the spirit of the invention are also included in the present invention. Also, appropriate combination of parts of the above described embodiments may be made.

For example, the content scrolled and displayed on the display unit is not limited to information of addresses of an address book. The present invention may be adopted to display various data that can be scrolled and displayed. Also, the direction of the scrolling is not limited to an upward/downward orientation and adoption to any direction of scrolling is possible.

Furthermore, the previously described information processing apparatus 101 includes various apparatuses. For example, personal computers, PDAs, mobile telephone terminals, printers, scanners, FAX machines, copy machines, multi function devices, cameras, video cameras, other image viewers, and the like are included.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-211532, filed Sep. 25, 2012, which is hereby incorporated by reference herein in its entirety.

What is claimed is:

1. An information processing apparatus having a display unit, comprising:
a detection unit configured to detect a user operation on a display screen of the display unit;
a determination unit configured to determine that a scroll on a scroll area of the display screen is instructed in a case where the detection unit detected that the user operation continues inside the scroll area after the detection unit detected a starting point of the user operation outside of the scroll area;
and a scroll unit configured to scroll an image displayed on the scroll area, in accordance with a direction of the user operation, in a case that the determination unit determines that the scroll is instructed.

2. The information processing apparatus according to claim 1, wherein the scroll unit performs the scroll in accordance with a distance from the starting point of the user operation to a point at which the user operation is detected to continue inside the scroll area.

3. The information processing apparatus according to claim 1, wherein the scroll unit performs the scroll in accordance with a distance from a starting point at which the user operation is detected to continue inside the scroll area after the starting point of the user operation outside of the scroll area is detected to a point at which the user operation is detected to continue inside the scroll area.

4. The information processing apparatus according to claim 1, wherein the user operation that continues is a MOVE operation.

5. The information processing apparatus according to claim 4, further comprising
a decision unit configured to decide whether or not to continue scrolling an image displayed in the scroll area in accordance with a movement distance and a speed of a MOVE operation before a TOUCH-UP when the detection unit detects the TOUCH-UP inside the scroll area after detecting the MOVE operation inside the scroll area,
wherein when the decision unit decides to continue scrolling, the scroll unit scrolls the image displayed inside the scroll area in accordance with the movement distance and the speed of the MOVE operation before the TOUCH-UP.

6. The information processing apparatus according to claim 5, wherein the decision unit decides to continue scrolling the image displayed inside the scroll area in a case that the detection unit detects a flick operation inside the scroll area.

7. The information processing apparatus according to claim 1, further comprising a control unit configured to control so that in a case that the detection unit detects that an operation button is displayed at a position of the starting point of the user operation outside of the scroll area of the display screen, the operation button is put into a pressed state, and in a case that the determination unit determines that the scroll is instructed, the pressed state of the operation button is cancelled and processing associated with the operation button is not executed.

8. The information processing apparatus according to claim 1, wherein the detection unit includes a touch panel.

9. The information processing apparatus according to claim 1, further comprising a unit configured to hide display of the scroll area in a case where the detection unit detects that the user operation does not continue inside the scroll area after the detection unit detects the starting point of the user operation outside of scroll area of the display screen wherein the scroll area is an area that is displayed in a pop-up or a drop-down upon an operation of a user.

10. A method of controlling an information processing apparatus having a display unit, the control method comprising:
detecting a user operation on a display screen of the display unit;
determining that a scroll on a scroll area of the display unit is instructed in a case where it is detected in the detecting step that the user operation continues inside the scroll area after a starting point of the user operation outside of the scroll area of the display screen is detected in the detecting step; and
scrolling an image displayed on the scroll area in a case that it is determined in the determining step that the scroll is instructed.

11. A non-transitory computer-readable storage medium storing a program for causing a computer to function as the information processing apparatus according to claim 1.
